(19) United States
(12) Patent Application Publication
(10) Pub. No.: US 2015/0263549 A1
(43) Pub. Date: Sep. 17, 2015

(54) CONNECTOR FOR ELECTRICAL CONNECTION FOR ELECTRICALLY DRIVEN VEHICLE

(71) Applicant: Panasonic Intellectual Property Management Co., Ltd., Osaka-shi, Osaka (JP)

(72) Inventors: Haeree Lee, Osaka (JP); Takuya Kagawa, Kyoto (JP); Tetsuji Shibata, Osaka (JP); Jun Goda, Osaka (JP)

(73) Assignee: PANASONIC INTELLECTUAL PROPERTY MANAGEMENT CO., LTD., Osaka-shi, Osaka (JP)

(21) Appl. No.: 14/431,377

(22) PCT Filed: Sep. 19, 2013
(86) PCT No.: PCT/JP2013/005523

§ 371 Date: Mar. 26, 2015

(30) Foreign Application Priority Data
Sep. 28, 2012 (JP) 2012-217614

(51) Int. Cl. H02J 7/00; H02H 3/06; H02H 3/08; B60L 11/18

(52) U.S. Cl. CPC H02J 7/0031; B60L 11/1816; H02H 3/06; H02H 3/08

(57) ABSTRACT

This connector for electrical connection for electrically driven vehicle includes: a contact portion configured to electrically connect an electric cable, electrically connected with one of an electrically driven vehicle or a power apparatus, with the other; and a main body. Main body houses therein the contact portion, a power cutoff portion and a first abnormality detector. Power cutoff portion is configured to switch opening/closing of a feed line between the electrically driven vehicle and the power apparatus. First abnormality detector is configured to detect an abnormality that occurs in the feed line, or externally receive an abnormal signal. Power cutoff portion is configured to open the feed line, when first abnormality detector detects the abnormality or receives the abnormal signal. First abnormality detector is configured to detect, as the abnormality, at least one of a short-circuit current in the feed line or an overload current in the feed line.

### TECHNICAL FIELD

The invention relates to a connector for electrical connection for an electrically driven vehicle.

### BACKGROUND ART

For example, Document 1 (JP 2010-110055 A) discloses a charging cable for charging of a battery mounted in an electrically driven vehicle, such as an electric vehicle (EV) or a plug-in hybrid electric vehicle (PHEV).

The charging cable includes: a power plug to be detachably connected with a power receptacle of a commercial power supply; and a connector for vehicle to be detachably connected with the electrically driven vehicle for supplying a charging current to the battery of the electrically driven vehicle. The power plug and the connector for vehicle are connected with each other via an electric cable. The electric cable is provided with a control box that is interposed therein. The control box stores therein: a switching circuit that is configured to switch opening/closing of an electric circuit between the power plug and the connector for vehicle; and a control circuit that is configured to stop electric power received from the commercial power supply by allowing the switching circuit to open the electric circuit, when detecting an abnormality during charging.

Regarding the charging cable, when the power plug is connected with the power receptacle and the connector for vehicle is connected with the electrically driven vehicle, the charging of the battery is performed, using the electric power from the commercial power supply. Further, regarding the charging cable, when an abnormality (such as an increase in temperature of the power plug, or electrical leakage) occurs during the charging of the battery, the control circuit detects the abnormality, and allows the switching circuit to open the electric circuit to stop the charging of the battery. In this way, it is possible to protect circuits upon the occurrence of the abnormality.

Here, regarding the charging cable disclosed in the above-mentioned Document 1, the control box is interposed in the electric cable, and accordingly, the control box may become an obstacle when the electric cable is returned to its original place. Although there has been provided a charging cable without such a control box, such a charging cable has no function of detecting an abnormality occurring in an electric circuit. Accordingly, in order to have function of detecting an abnormality, it has been required to interpose the control box in the electric cable.

In addition, the conventional control circuit is merely provided for stopping the electric power from the commercial power supply. When an abnormality occurs in a wiring region between the control box and a connector connected with a storage battery (i.e., EV), a protective function with respect to electric power from the storage battery side is not sufficient. Therefore, recently, further enhancement of the protective function is desired. When a short-circuit abnormality occurs in the above-mentioned region, a protective function with respect to a short-circuit current caused by electric power from the electrically driven vehicle (storage battery) is not sufficient. Also, even when the electric circuit is opened in the control box according to an electrical leakage abnormality occurring in the above-mentioned region, an electrical leakage with respect to electric power from the electrically driven vehicle (storage battery) is not sufficiently protected.

### DISCLOSURE OF THE INVENTION

The present invention has been made in the light of the above-mentioned problem, and it is an object thereof to provide a connector, which can further enhance electric safety while improving usability, for electrical connection for an electrically driven vehicle.

A connector for electrical connection for an electrically driven vehicle, according to a first aspect of the present invention, is configured to electrically connect the electrically driven vehicle, which includes a power storage portion, with a power apparatus. The power apparatus is configured to control at least one of supplying of electric power to the electrically driven vehicle or supplying of electric power from the electrically driven vehicle. The connector includes a contact portion and a main body. The contact portion is configured to electrically connect an electric cable, electrically connected with one of the electrically driven vehicle or the power apparatus, with the other of the electrically driven vehicle or the power apparatus. The main body houses therein the contact portion, a power cutoff portion and a first abnormality detector. The power cutoff portion is configured to switch opening/closing of a feed line between the electrically driven vehicle and the power apparatus. The first abnormality detector is configured to detect an abnormality that occurs in the feed line, or externally receive an abnormal signal. The power cutoff portion is configured to open the feed line, when the first abnormality detector detects the abnormality or receives the abnormal signal. The first abnormality detector is configured to detect, as the abnormality, at least one of a short-circuit current in the feed line or an overload current in the feed line.

As a connector for electrical connection for an electrically driven vehicle according to a second aspect of the present invention, in the first aspect, the power cutoff portion includes an electric conductor connected in series with the electric cable, and the power cutoff portion is configured to switch opening/closing of the feed line by bringing a first end of the electric conductor into contact with a second end of the electric conductor or releasing the electric conductor from a contact state. The main body further houses therein an abnormality transmitter and a switching mechanism. The abnormality transmitter is configured to mechanically release the electric conductor from the contact state, when the first abnormality detector detects the abnormality or receives the abnormal signal. The switching mechanism is configured to mechanically bring the first end of the electric conductor into contact with the second end of the electric conductor or release the electric conductor from the contact state, in a state where the first abnormality detector detects no abnormality and receives no abnormal signal.

As a connector for electrical connection for an electrically driven vehicle according to a third aspect of the present invention, in the second aspect, when the contact portion is connected with the electrically driven vehicle or the power apparatus, the switching mechanism is configured to bring the first end of the electric conductor into contact with the second end of the electric conductor after connection of the contact portion is completed, and when the contact portion is disconnected with the electrically driven vehicle or the power apparatus, the switching mechanism is configured to release the electric conductor from the contact state before disconnection of the contact portion is completed.

As a connector for electrical connection for an electrically driven vehicle according to a fourth aspect of the present invention, in any one of the first to third aspects, the first abnormality detector is configured to further detect, as the abnormality, at least one of a ground fault current in the feed line, a leakage current in the feed line, a connection failure of the contact portion, or a temperature abnormality that occurs at the contact portion.

As a connector for electrical connection for an electrically driven vehicle according to a fifth aspect of the present invention, the connector in any one of the second to fourth aspects further includes a signal receiver configured to receive the abnormal signal that is output from a second abnormality detector provided outside the main body. The abnormality transmitter is configured to release the electric conductor from the contact state when the signal receiver receives the abnormal signal.

As a connector for electrical connection for an electrically driven vehicle according to a sixth aspect of the present invention, in any one of the second to fifth aspects, the electric conductor includes: a fixed contactor; and a movable contactor to be separably brought into contact with the fixed contactor. The electric conductor is housed in a first casing formed of insulating material. The power cutoff portion further includes a pair of permanent magnets and a yoke. The permanent magnets are disposed while an N-pole of one of the permanent magnets faces an S-pole of the other of the permanent magnets so as to hold, between the permanent magnets, an electric arc that is generated by the movable contactor being separated from the fixed contactor. The yoke is magnetically connected with the permanent magnets so as to form a magnetic path together with the permanent magnets. The yoke is disposed outside the first casing, and the permanent magnets are disposed at portions outside the first casing, corresponding to the fixed contactor and the movable contactor.

As a connector for electrical connection for an electrically driven vehicle according to a seventh aspect of the present invention, in the sixth aspect, the first casing is configured as a second casing housing therein at least the power cutoff portion, the first abnormality detector, the abnormality transmitter and the switching mechanism.

As a connector for electrical connection for an electrically driven vehicle according to an eighth aspect of the present invention, in the sixth or seventh aspect, the permanent magnets are disposed near the fixed contactor so as to turn according to operation of the switching mechanism to change a direction of a magnetic field.

As a connector for electrical connection for an electrically driven vehicle according to a ninth aspect of the present invention, in any one of the sixth to eighth aspects, the power cutoff portion further includes an extinguishing portion. The extinguishing portion includes an arc running plate and an extinguishing grid plate. The arc running plate is configured to transfer the electric arc generated by the movable contactor being separated from the fixed contactor. The extinguishing grid plate is configured to extinguish the electric arc transferred by the arc running plate.

As a connector for electrical connection for an electrically driven vehicle according to a tenth aspect of the present invention, in the first aspect, the power cutoff portion includes a switch and an on/off-switching portion. The switch is connected in series with the electric cable. The on/off-switching portion is configured to switch on/off of the switch to switch opening/closing of the feed line. The main body houses therein a switch-off portion that is configured to turn off the switch, when the first abnormality detector detects the abnormality or receives the abnormal signal.

As a connector for electrical connection for an electrically driven vehicle according to an eleventh aspect of the present invention, in the tenth aspect, when the contact portion is connected with the electrically driven vehicle or the power apparatus, the on/off-switching portion is configured to turn on the switch after connection of the contact portion is completed, and when the contact portion is disconnected with the electrically driven vehicle or the power apparatus, the on/off-switching portion is configured to turn off the switch before disconnection of the contact portion is completed.

As a connector for electrical connection for an electrically driven vehicle according to a twelfth aspect of the present invention, in the tenth or eleventh aspect, the first abnormality detector is configured to further detect, as the abnormality, at least one of a ground fault current in the feed line, a leakage current in the feed line, a connection failure of the contact portion, or a temperature abnormality that occurs at the contact portion.

### BRIEF DESCRIPTION OF THE DRAWINGS

FIG. 1 is a schematic block diagram illustrating one example of a connector for electrical connection for an electrically driven vehicle according to an embodiment;

FIG. 2 is a schematic block diagram illustrating another example of the connector for electrical connection according to the embodiment;

FIG. 3 is a schematic block diagram illustrating yet another example of the connector for electrical connection according to the embodiment;

FIG. 4 is an external perspective view of the connector for electrical connection according to the embodiment;

FIG. 5 is an overall perspective view of an internal structure of the connector for electrical connection according to the embodiment;

FIG. 6 is a front view of an internal structure of a contact mechanism portion in the connector for electrical connection according to the embodiment;

FIG. 7 is an overall perspective view of one example of a DC extinguishing device used for the contact mechanism portion in the connector for electrical connection according to the embodiment;

FIG. 8 is an explanatory drawing for a procedure for connecting, with the electrically driven vehicle, the connector for electrical connection according to the embodiment;

FIG. 9 is an explanatory drawing for the procedure for connecting, with the electrically driven vehicle, the connector for electrical connection according to the embodiment;

FIG. 10 is an explanatory drawing for the procedure for connecting, with the electrically driven vehicle, the connector for electrical connection according to the embodiment;

FIG. 11 is an overall perspective view of another example of the contact mechanism portion in the connector for electrical connection according to the embodiment;

FIG. 12 is a plan view of another example of the DC extinguishing device used for the contact mechanism portion in the connector for electrical connection according to the embodiment;

FIG. 13 is a partially enlarged view of yet another example of the DC extinguishing device used for the contact mechanism portion in the connector for electrical connection according to the embodiment;

FIG. 14 is a partially enlarged view of yet another example of the DC extinguishing device used for the contact mechanism portion in the connector for electrical connection according to the embodiment;

FIG. 15 is a schematic diagram illustrating another example of a power cutoff portion in the connector for electrical connection according to the embodiment; and

FIG. 16 is an external perspective view of another example of the connector for electrical connection according to the embodiment.

### EMBODIMENTS FOR CARRYING OUT THE INVENTION

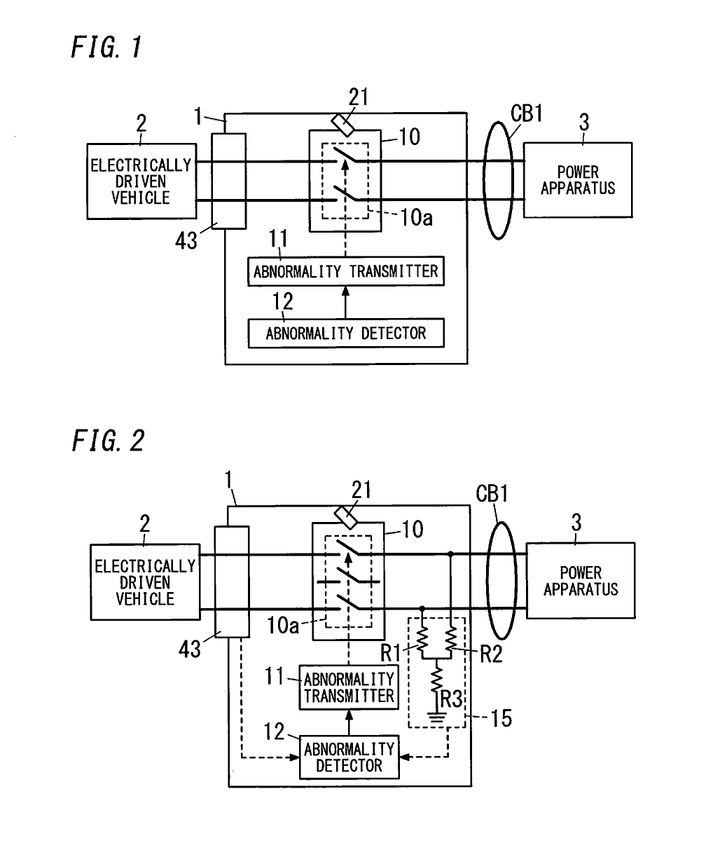

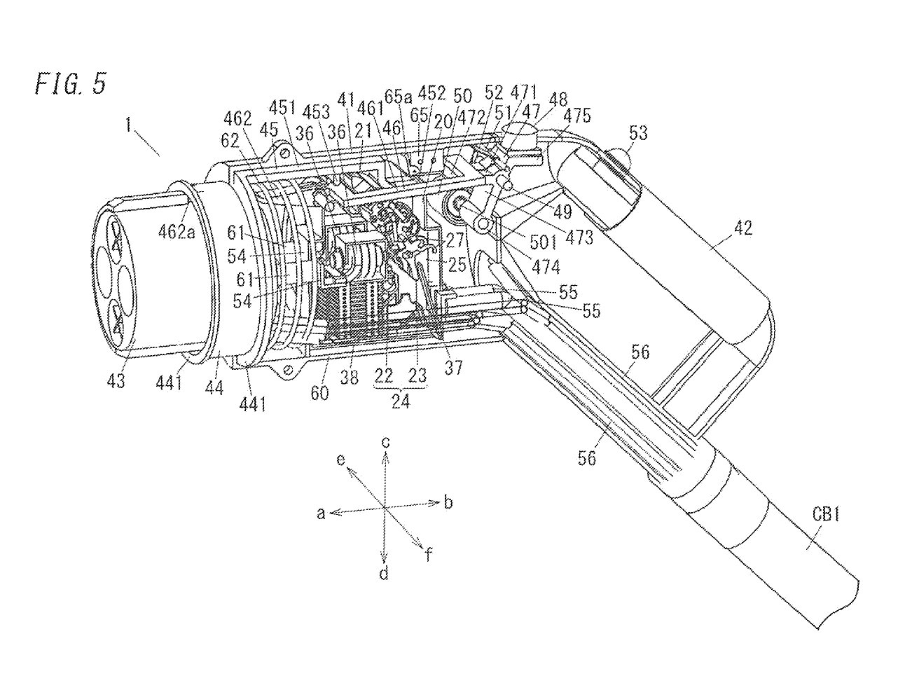

A connector 1 for electrical connection for an electrically driven vehicle (hereinafter, referred to as “connector 1 for electrical connection”) according to an embodiment will be described below with reference to FIGS. 1 to 16. For example as shown in FIG. 1, the connector 1 for electrical connection according to the embodiment is used for electrically connecting an electrically driven vehicle 2 with a power apparatus 3 to supply electric power from the power apparatus 3 to the electrically driven vehicle 2, or supply electric power from the electrically driven vehicle 2 to the power apparatus 3. In the following description, unless otherwise specified, a-b, c-d and e-f directions shown in FIG. 5 are defined as front-back, up-down and left-right directions, respectively.

Examples of the electrically driven vehicle 2 include an electric vehicle (EV) including as a power source only an electric motor, and a plug-in hybrid electric vehicle (PHEV) including as a power source an engine and an electric motor. A storage battery (not shown) is mounted in all of such vehicles.

The power apparatus 3 is for example a DC/AC power converter, and configured to convert, into DC power, AC power received from a commercial power supply, and supply the DC power to the storage battery of the electrically driven vehicle 2.

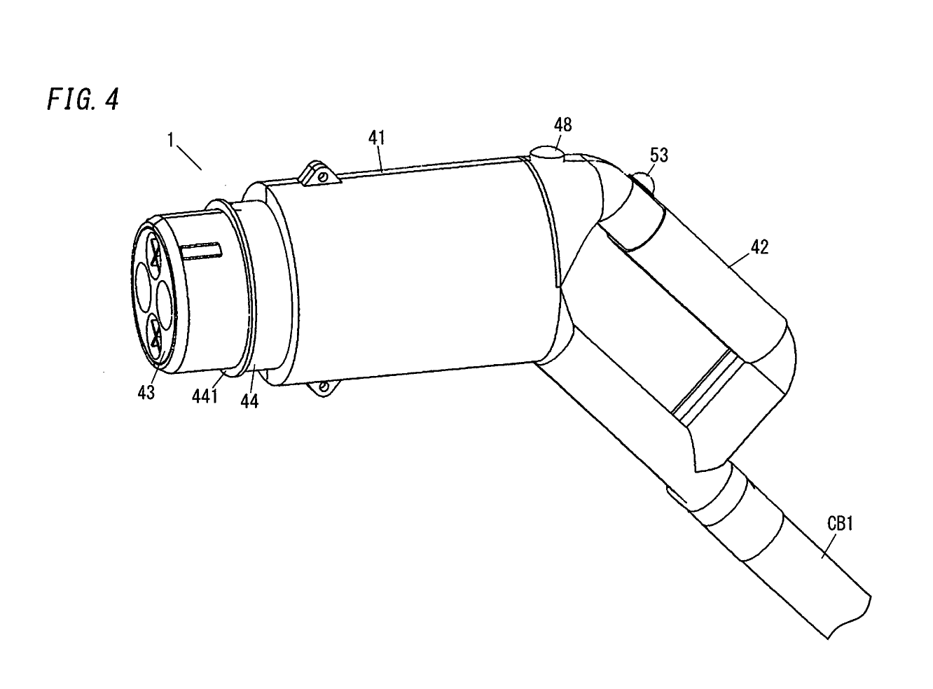

FIG. 4 is an external perspective view of the connector 1 for electrical connection. The size of the connector 1 for electrical connection is designed to the extent that an operator can connect it with a connector of the electric vehicle (EV) while holding with the operator's hand.

FIG. 1 is a schematic block diagram illustrating one example of the connector 1 for electrical connection according to the embodiment. The connector 1 for electrical connection includes a contact portion 43, a power cutoff portion 10, an abnormality transmitter 11, an abnormality detector 12 and a handle 21, and those components are housed in a main body 41 (see FIG. 4). The connector 1 for electrical connection is electrically connected with the power apparatus 3 through an electric cable CB1.

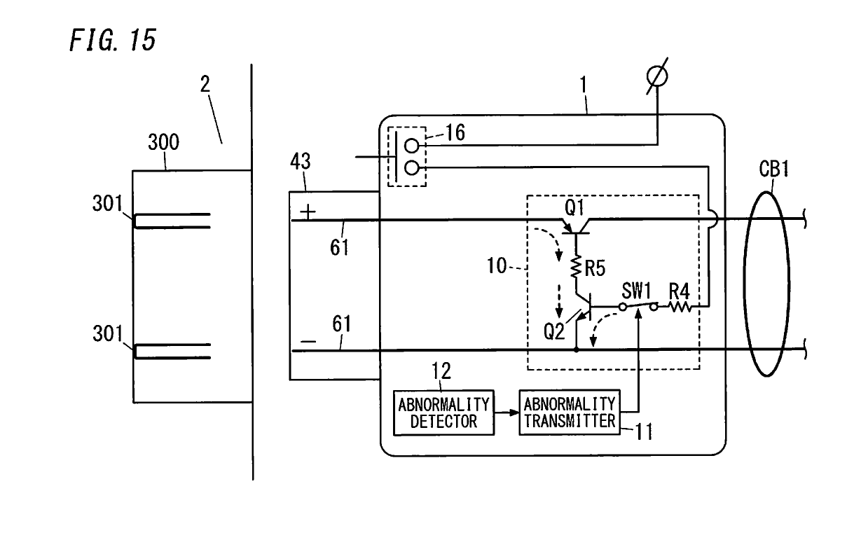

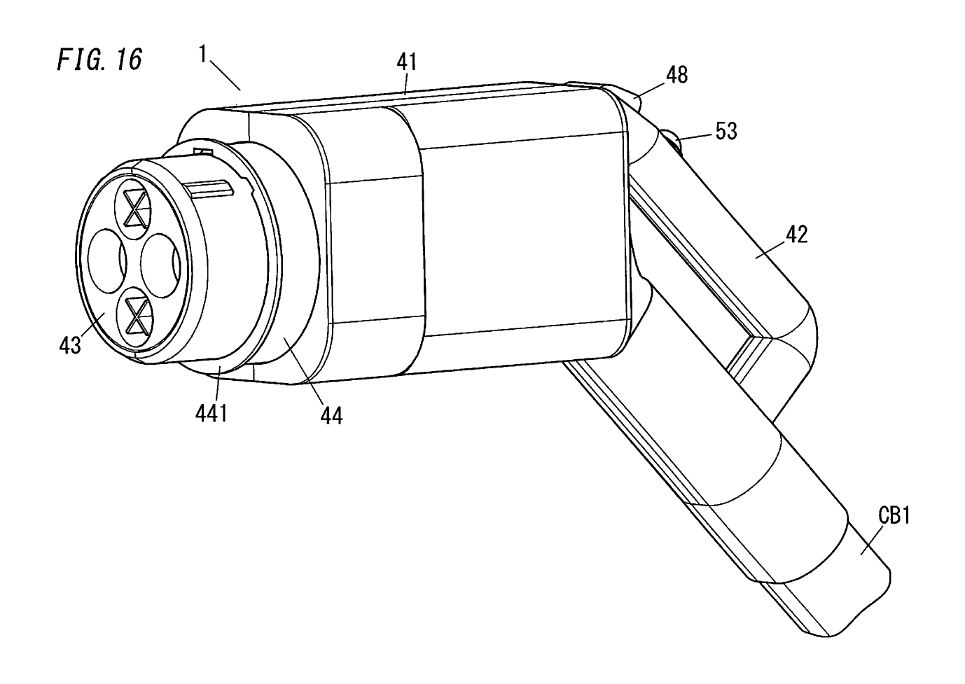

The contact portion 43 is configured to be removably inserted in and connected with a vehicle side inlet 300 (see FIG. 15) of the electrically driven vehicle 2. The electrically driven vehicle 2 is electrically connected with the power apparatus 3 by the contact portion 43 being connected with the vehicle side inlet 300.

The power cutoff portion 10 includes a pair of electric conductors 10a, which are respectively connected in series with two wires of the electric cable CB1. The power cutoff portion 10 is configured to switch opening/closing of a feed line between the electrically driven vehicle 2 and the power apparatus 3 by bringing a first end of the electric conductor 10a into contact with a second end of the electric conductor 10a or releasing the electric conductor 10a from a contact state.

The abnormality detector 12 is configured to detect an abnormality (such as a short-circuit current or an overload current) that occurs in the feed line between the electrically driven vehicle 2 and the power apparatus 3. Here in the embodiment, the abnormality detector 12 corresponds to a first abnormality detector.

The abnormality transmitter 11 has a function of mechanically releasing the electric conductor(s) 10a of the power cutoff portion 10 from the contact state. When the abnormality detector 12 detects the above abnormality, the abnormality transmitter 11 mechanically releases the electric conductor(s) 10a from the contact state to open the feed line. Accordingly, supplying of electric power from the power apparatus 3 to the electrically driven vehicle 2 is stopped.

The handle 21 has a function of mechanically bringing first ends of the electric conductors 10a of the power cutoff portion 10 into contact with second ends of the electric conductors 10a, and a function of mechanically releasing the electric conductors 10a from the contact state. The handle 21 is configured to bring the first ends of the electric conductors 10a into contact with the second ends of the electric conductors 10a or release the electric conductors 10a from the contact state for closing or opening of the feed line, in a state where the abnormality detector 12 detects no abnormality.

FIG. 5 is an overall perspective view of an internal structure of the connector 1 for electrical connection according to the embodiment. The connector 1 for electrical connection further includes a slide lever 45, a lock lever 46, a release lever 47, a solenoid device 50, a contact mechanism portion 60 and a microswitch 65, and those components are housed in the main body 41 formed into a cylindrical shape.

Further, a U-shaped handle 42 is provided at a rear end portion of the main body 41 while formed integrally with the rear end portion. The electric cable CB1 is in a state of being led out from a rear end portion of the handle 42. The electric cable CB1 includes a first cable 55 for supplying electric power, and a second cable 56 for transmitting signal. The handle 42 is provided with an LED lamp 53. By the LED lamp 53, a locking state and an abnormality state are indicated.

The slide lever 45 includes a lever main body 451 formed as a rectangle plate extending in the front-back direction. The lever main body 451 is provided at a rear end portion thereof with an engagement projection 452. The lever main body 451 is further provided at a middle portion thereof with a flange 453 projecting downward. The slide lever 45 is provided integrally with a rear end portion of a tubular body 44. The tubular body 44 is provided at both ends thereof in the front-back direction with flange portions 441, respectively. The slide lever 45 is configured to slide in the front-back direction by the tubular body 44 sliding in the front-back direction with respect to the main body 41.

The tubular body 44 is in a state of receiving elastic force applied toward the front direction, depending on spring force of a return spring 62. In a state where the connector 1 for electrical connection is not connected with the vehicle side inlet 300, the back side flange portion 441 is in a state of abutting on a front surface of the main body 41 from the inside of the main body 41 (see FIG. 5).

The lock lever 46 is for locking the connector 1 for electrical connection to the vehicle side inlet 300 (see FIG. 15) of the electrically driven vehicle 2. The lock lever 46 includes: a first member 461 that is U-shaped and extends in the front-back direction; and a second member 462 that is bar-shaped and mounted to an end portion (front end portion) of the first member 461. The second member 462 is provided at an end portion thereof with an engagement projection 462a.

The second member 462 is in a state of receiving elastic force applied upward by a torsion spring. When the tubular body 44 is moved backward, the engagement projection 462a is moved upward, depending on the elastic force. Further, when a release button 48 described later is pressed, a rear portion of the first member 461 is pushed up by the release lever 47 being moved upward, and accordingly, the second member 462 is pushed down.

According to the lock lever 46, the connector 1 for electrical connection is locked to the vehicle side inlet 300 by the engagement projection 462a of the second member 462 being engaged with an engagement groove (not shown) provided in the vehicle side inlet 300.

The release lever 47 includes a lever main body 471 formed as a rectangle plate extending in the front-back direction. The lever main body 471 is provided at an end portion (front end portion) thereof with an engagement projection 472. The lever main body 471 is further provided at a rear end portion thereof with a supporting plate 475. The circular-shaped release button 48 is disposed on an upper surface of the supporting plate 475. The lever main body 471 is further provided on a lower surface thereof with an extended plate 473 that is inclined obliquely downward. The extended plate 473 is provided at an end portion thereof with a tubular portion 474.

The release lever 47 is pivotably supported by a shaft member 49 attached to the main body 41. The release lever 47 is in a state of receiving elastic force applied downward, depending on spring force of a biasing spring 52 that is fixed to a shaft member 51 attached to the main body 41. Accordingly, in order to operate the release lever 47, the release button 48 needs to be pressed downward against the spring force of the biasing spring 52. Then, when the operator's hand is released from the release button 48, the release lever 47 and the release button 48 are returned to original positions thereof by the spring force of the biasing spring 52.

The solenoid device 50 includes a pin 501 that is protruded so as to be freely advanced and retreated along the left-right direction. In a state of being advanced, the pin 501 is inserted into the tubular portion 474 of the release lever 47, and accordingly, the release lever 47 falls in a state of not accepting operation. This is for preventing the connector 1 for electrical connection from being removed from the vehicle side inlet 300 even when the release button 48 is incorrectly pressed during charging of the electrically driven vehicle 2, for example.

The microswitch 65 includes a bar-shaped lever 65a for turning on/off a contact (not shown) provided inside the microswitch 65. The on/off of the contact is switched according to the pressing force applied to the lever 65a from the slide lever 45. Specifically, in a state where the connector 1 for electrical connection is not connected with the vehicle side inlet 300, the pressing force is not applied to the lever 65a from the slide lever 45, and accordingly, the contact is in an OFF state.

When the connector 1 for electrical connection is connected with the vehicle side inlet 300, the pressing force is applied to the lever 65a from the slide lever 45, and accordingly, the contact falls in an ON state. A contact signal by the microswitch 65 is output to the solenoid device 50. When the contact of the microswitch 65 is turned on, the solenoid device 50 is driven and the pin 501 falls in the advanced state.

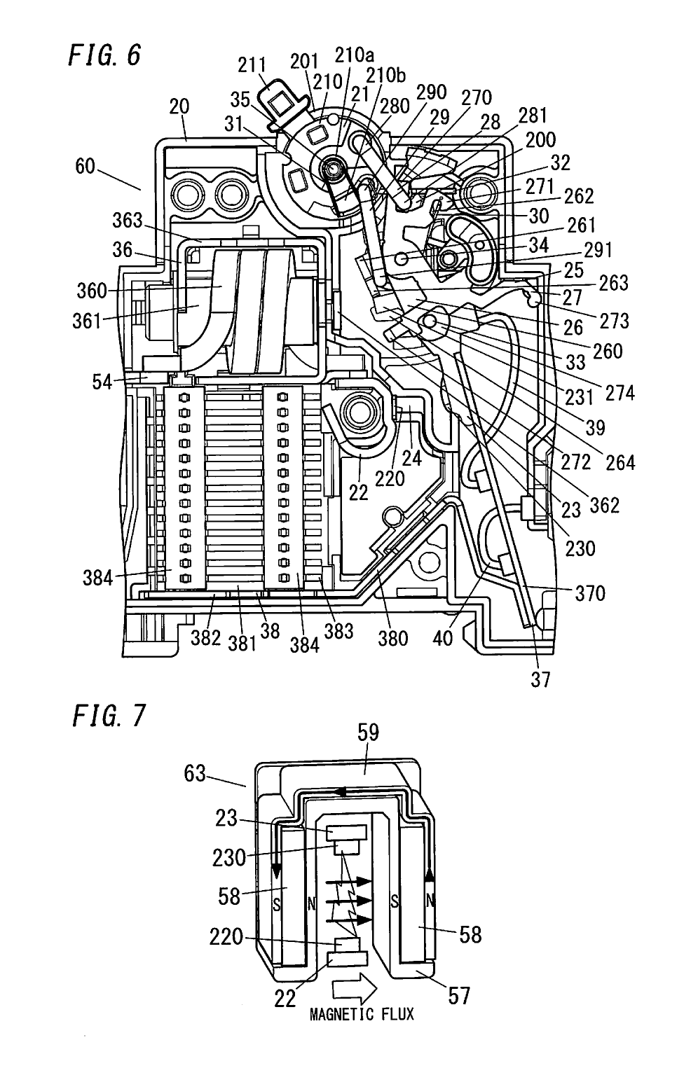

As shown in FIG. 6, the contact mechanism portion 60 includes a contact mechanism 24 and a link mechanism 25. The contact mechanism 24 includes two sets, each of which includes a fixed contact 220 and a movable contact 230. The link mechanism 25 includes the handle 21 that is provided with an operation knob 211. The electrically connections between the fixed contacts 220 and the movable contacts 230 are switched on/off by the handle 21.

The contact mechanism portion 60 further includes a trip mechanism (electromagnetic releasing portions 36 and thermal releasing portions 37) and extinguishing devices 38. When detecting an abnormal current (a short-circuit current and an overload current) between the fixed contact 220 and the movable contact 230, the trip mechanism is configured to allow the link mechanism 25 to perform trip operation to forcibly open a contact. Each extinguishing device 38 is configured to rapidly extinguish an electric arc that is generated when the contact is opened. Those components are housed in a housing 20 formed as a rectangle box.

The contact mechanism 24 further includes two sets, each of which includes: a fixed contact plate 22 on which a fixed contact 220 is provided; and a movable bar 23 on which a movable contact 230 is provided. The fixed contact plates 22 and the movable bars 23 are formed by punching and bending metal plates with prescribed thicknesses.

The movable bars 23 are T-shaped, and the movable contacts 230 are disposed on lower portions of the movable bars 23. Each movable bar 23 is provided on a right side of an upper portion thereof with a spring receiving piece (not shown), and further on a left side of the upper portion with a stopper piece 231. Further, one end of a braided wire 39 is secured to a middle portion of the movable bar 23 in a length direction (the up-down direction). By linking with the link mechanism 25, each movable bar 23 is movable between a position where the movable contact 230 is in contact with the fixed contact 220 and a position where the movable contact 230 is separated from the fixed contact 220.

Here in the embodiment, the fixed contact 220 corresponds to a fixed contactor, and the moveable contact 230 corresponds to a moveable contactor. In the embodiment, the respective electric conductors 10a are constituted by the two sets, each of which includes the fixed contact 220 and the movable contact 230. The power cutoff portion 10 is constituted by the fixed contact plates 22 and the movable bars 23.

The link mechanism 25 includes the handle 21, supporting arms 26, latch members 27, first link members 28, second link members 29, latch springs 30, link springs 31, a handle spring 32, pressure springs (not shown), first turning shafts 33 and second turning shafts 34.

The handle 21 includes: a main body 210 that is formed of synthetic resin into an approximately cylindrical shape; and the operation knob 211 that has approximately rectangular parallelepiped shape and is provided on an outer peripheral surface of the main body 210. The main body 210 is provided with a shaft hole 210a formed along a central axis of the main body 210. Further, the main body 210 is provided in each of both side surfaces thereof (e.g., a front surface in FIG. 6) with a guide groove 210b which extends along a circumferential direction.

The handle 21 is pivotably supported by a handle shaft 35 attached to the housing 20 in a state where the operation knob 211 is exposed through an operation opening 201 of the housing 20. The operation knob 211 is pivotably between an opening position where the contact mechanism 24 is made to be opened and a closing position where the contact mechanism 24 is made to be closed.

The supporting arms 26 and the latch members 27 are formed by punching and bending metal plates with prescribed thicknesses. The first and second link members 28 and 29 are formed into approximately U-shapes by bending both ends of metal round bars in one direction. The latch springs 30, the link springs 31, the handle spring 32 and the pressure springs are provided as torsion coil springs, each of which has both ends projecting in mutually reverse directions. The first and second turning shafts 33 and 34 are formed of metal round bars.

Each supporting arm 26 includes a pair of side plates 260 (FIG. 6 shows only a side plate on a near side) arranged in the left-right direction (a direction perpendicular to a paper plane of FIG. 6). The side plates 260 are coupled to each other via a middle piece 261. One of the side plates 260 (on the near side) is provided at an upper end thereof with an engagement projecting piece 262 extending obliquely upward. The other of the side plates 260 (on a far side) is provided at an approximately center of a side edge thereof with a projecting piece 264 that is approximately L-shaped, of which an end projects upward.

Further, the middle piece 261 is provided at a lower end thereof with an engagement piece 263 that projects downward to face the stopper piece 231 of the corresponding movable bar 23. The first turning shaft 33 and the second turning shaft 34 are respectively inserted into holes provided in the corresponding supporting arm 26. The supporting arms 26 are pivotably supported by the second turning shafts 34 attached to the housing 20.

The upper portion of each movable bar 23 is interposed between the side plates 260 of the corresponding supporting arm 26. The movable bars 23 are pivotably supported by the supporting arms 26 via the first turning shafts 33. When the supporting arm 26 is turned around the second turning shaft 34, the movable bar 23 is moved together with the supporting arm 26.

Each latch member 27 is provided on one side (a left side in FIG. 6) of an upper portion thereof with a pawl piece 270 that is L-shaped, and on the other side (a right side in FIG. 6) of the upper portion with a spring receiving piece 271 that is L-shaped. Each latch member 27 is further provided with a first pressing piece 272 that extends from an edge on one side of a lower portion of the latch member 27. Each latch member 27 is further provided with a second pressing piece 273 that is approximately L-shaped and extends from an edge on the other side of the lower portion.

The respective second turning shafts 34 are inserted into holes provided in approximately central portions of the latch members 27. The latch members 27 are pivotably supported by the second turning shafts 34. Each latch member 27 is provided at a lower end portion thereof with a cutout portion 274 that is approximately rectangle-shaped. The first turning shafts 33 are engaged with the cutout portions 274.

Each first link member 28 includes an upper leg portion 280 and a lower leg portion 281. The upper leg portion 280 is pivotably supported by a shaft hole (not shown) provided in the handle 21. The lower leg portion 281 is removably engaged with an engagement portion 200 that is constituted by the pawl piece 270 of the latch member 27 and the engagement projecting piece 262 of the supporting arm 26. Each second link member 29 includes an upper leg portion 290 and a lower leg portion 291. The respective upper leg portions 290 are engaged into the guide grooves 210b of the handle 21. The respective lower leg portions 291 are hooked and locked to the engagement pieces 263 of the supporting arms 26.

The respective second turning shafts 34 are inserted into winding parts of the latch springs 30. One ends of the latch springs 30 are respectively locked to the spring receiving pieces 271 of the latch members 27. Accordingly, the respective latch springs 30 are in states of applying elastic force clockwise (clockwise in FIG. 6) against the latch members 27. The handle shaft 35 is inserted into winding parts of the link springs 31. One end portions of the link springs 31 are disposed so as to abut on the handle 21 while the other end portions of the link springs 31 respectively abut on the upper leg portions 290 of the second link members 29. Accordingly, the respective link springs 31 are in states of applying elastic force in the right direction against the second link members 29.

Each electromagnetic releasing portion 36 as one constituent element of the trip mechanism includes a coil 360 as a flat-type winding, a coil bobbin 361, a fixed iron core and a movable iron core (not shown) formed of magnetic material, a return spring (not shown), a pressing pin 362 coupled to the movable iron core, and a yoke 363. The respective fixed contact plates 22 are fixed to one ends of the coils 360, and respective terminal plates 54 are fixed to the other ends of the coils 360.

Each yoke 363 is formed of magnetic material and has a hollow rectangular-frame shape with a cutout part. The respective coil bobbins 361 are disposed so as to be surrounded by the yokes 363. Each yoke 363 is provided in a rear end portion (a right end portion in FIG. 6) thereof with a through-hole (not shown) into which the corresponding pressing pin 362 is inserted.

Regarding each electromagnetic releasing portion 36, in a state where no current flows through the coil 360, the movable iron core is separated from the fixed iron core by spring force of the return spring, and the pressing pin 362 coupled to the movable iron core is in a retracted state, as shown in FIG. 6. In this state, when an excessive current such as a short-circuit current flows through the coil 360, the movable iron core is moved so as to come closer to the fixed iron core against the spring force of the return spring, and accordingly, the pressing pin 362 coupled to the movable iron core is projected backward (in the right direction in FIG. 6).

Then, an end portion of the pressing pin 362 presses the first pressing piece 272 of the latch member 27 backward, and the movable bar 23 is moved backward together with the latch member 27, and accordingly, the movable contact 230 is separated from the fixed contact 220. Therefore, the feed line of electric power to be fed from the power apparatus 3 to the electrically driven vehicle 2 is cut off, and supplying to the electrically driven vehicle 2 is stopped.

Each thermal releasing portion 37 as the other constituent element of the trip mechanism includes a bimetal plate 370 that is strip-shaped, as shown in FIG. 6. Examples of the bimetal plate 370 include a directly heated type of bimetal plate that is curved by self-heating, and an indirectly heated type of bimetal plate that is curved by heating from a plate-shaped heater stacked on the bimetal plate. One ends of the braided wires 39 are secured to the movable bars 23, and the other ends of the braided wires 39 are secured to middle portions of bimetal plates 370, respectively. One ends of braided wires 40 are secured to lower portions of the bimetal plates 370, respectively.

In normal situation, the bimetal plates 370 are in non-curved states. When an excessive current such as an overload current flows through the bimetal plate 370, temperature of the bimetal plate 370 is increased due to the overload current, and accordingly, the bimetal plate 370 is curved. Then, according to curving of the bimetal plate 370, an end portion (an upper end portion) of the bimetal plate 370 presses the second pressing piece 273 of the latch member 27 backward (toward the right side in FIG. 6), and the movable bar 23 is moved backward together with the latch member 27, and accordingly, the movable contact 230 is separated from the fixed contact 220.

Therefore, the feed line of electric power to be fed from the power apparatus 3 to the electrically driven vehicle 2 is cut off, and supplying to the electrically driven vehicle 2 is stopped. In the embodiment, the abnormality transmitter 11 and the abnormality detector 12 are constituted by the electromagnetic releasing portion 36 and the thermal releasing portion 37.

As shown in FIG. 6, each extinguishing device 38 includes an arc running plate 380 and an extinguishing grid 381. The arc running plate 380 is formed by bending a strip-shaped metal plate. One end of the arc running plate 380 is coupled to a base portion of the bimetal plate 370. The arc running plate 380 is provided at the other end thereof with an extinguishing piece 382.

The extinguishing grid 381 includes: a plurality of extinguishing plates 383, as a plurality of conductive plates arranged in parallel at prescribed intervals in the up-down direction; and two supporting plates 384, 384 formed of insulating material. The supporting plates 384, 384 cover both side surfaces of the plurality of extinguishing plates 383 in width directions thereof to hold the plurality of extinguishing plates 383 at the prescribed intervals. The extinguishing grid 381 is disposed between the extinguishing piece 382 and a lower side portion of the yoke 363. Here in the embodiment, the extinguishing device 38 corresponds to an extinguishing portion.

Next, operation of the contact mechanism portion 60 will be described. FIG. 6 shows a state where the contact mechanism 24 is opened. In this state, when the main body 210 of the handle 21 is turned clockwise, the engagement projecting pieces 262 of the supporting arms 96 are pressed rightward by the lower leg portions 281 of the first link members 28. Accordingly, the respective supporting arms 26 are turned clockwise around the second turning shafts 34. At this time, the movable bars 23 pivotably supported by the first turning shafts 33 are also moved leftward according to moving of the supporting arms 26, respectively.

Here, regarding each second link member 29, when being on a right side of a line segment between the lower leg portion 291 and the handle shaft 35, the upper leg portion 290 is moved downward by turning of the handle 21. At this time, the lower leg portions 291 of the second link members 29 press the stopper pieces 231 of the movable bars 23 downward, respectively. In other words, the movable bars 23 are pressed counterclockwise by the lower leg portions 291 of the second link members 29, while receiving elastic force clockwise around the first turning shafts 33 from the pressure springs (not shown), respectively.

In this state, when the handle 21 is further turned clockwise, the upper leg portion 290 of each second link member 29 is moved toward a left side of the line segment between the lower leg portion 291 and the handle shaft 35. Therefore, the second link members 29 are pulled up. At this time, the lower leg portions 291 of the second link members 29 are moved upward, and the pressing force against the stopper pieces 231 of the movable bars 23 is eliminated, and accordingly, the movable bars 23 are respectively rapidly turned clockwise around the first turning shafts 33 by spring force of the pressure springs. Therefore, the respective movable contacts 230 vigorously abut on the fixed contacts 220.

Electric arc generation can be suppressed by the respective movable contacts 230 coming into contact with the fixed contacts 220 in a short time as described above. The latch members 27 are turned clockwise by spring force of the latch springs 30.

In a state where the contact mechanism 24 is closed, when the main body 210 of the handle 21 is turned counterclockwise, the lower leg portions 281 of the first link members 28 are pulled up. Accordingly, pressing force of the first link members 28 against the supporting arms 26 is eliminated. The movable bars 23 are respectively turned clockwise around the first turning shafts 33 by spring force of the pressure springs, and the supporting arms 26 are respectively turned counterclockwise around the second turning shafts 34 by spring force of the pressure springs.

The supporting arms 26 are stopped when the first turning shafts 33 are moved to positions of rear ends (positions of right ends in FIG. 6) of guide ribs (not shown). The movable bars 23 are stopped at positions where the stopper pieces 231 abut on the engagement pieces 263 of the supporting arms 26, respectively. Therefore, the respective movable contacts 230 are separated from the fixed contacts 220.

Here, the handle 21 is biased by the handle spring 32 toward an open position where the contact mechanism is opened (i.e., counterclockwise). When the upper leg portion 280 of each first link member 28 is moved from a left side of a line segment between the handle shaft 35 and the lower leg portion 281 of the each first link member 28 to a right side of the line segment frnm a left side thereof, the handle 21 is rapidly turned toward the open position where the contact mechanism is opened. Therefore, the respective movable contacts 230 are rapidly separated from the fixed contacts 220, and the electric arc generation can be suppressed. The latch members 27 are pulled by the lower leg portions 281 of the first link members 28, and turned counterclockwise around the second turning shafts 34, respectively.

Here, in a case where electric power to be supplied from the power apparatus 3 to the electrically driven vehicle 2 is DC power, arc drive force may not be sufficiently obtained in a small current region, and thereby an electric arc may not be guided to an extinguishing grid. In this case, it is impossible to cut off the electric arc. In order to solve this problem, in the embodiment, a DC extinguishing device 63 shown in FIG. 7 is provided to achieve cutting off of the electric arc even in the small current region.

The DC extinguishing device 63 includes a pair of permanent magnets 58, 58 that are plate-shaped, a yoke 59 that is U-shaped, and a casing 57 (first casing) in which the fixed contact plates 22 and the movable bars 23 are housed. The permanent magnets 58, 58 are disposed outside the casing 57 so that the fixed contact plates 22 and the movable bars 23 arranged in the up-down direction are between the permanent magnets 58, 58 in the left-right direction. Further, each permanent magnet 58 is disposed so that an S-pole thereof faces left and an N-pole thereof faces right.

The yoke 59 is disposed outside the casing 57 so as to hold the pair of the permanent magnets 58, 58 from the left side and the right side of the pair. Therefore, a magnetic path is formed in the permanent magnets 58, 58 and the yoke 59, and, as shown in FIG. 7, a magnetic field toward the right permanent magnet 58 from the left permanent magnet 58 is formed inside the casing 57. Then, the electric arc generated between the movable contact 230 and the fixed contact 220 is extended and cut off by electromagnetic force applied in a direction perpendicular to a paper plane of FIG. 7.

In this way, according to the DC extinguishing device 63, the electric arc can be extended and cut off by the electromagnetic force even in the small current region. Note that, this DC extinguishing device 63 is housed in the housing 20 so that the fixed contact plates 22 and the movable bars 23 are arranged in the casing 57. Here, portions corresponding to the fixed contact plate 22 and the movable bar 23 are, as shown in FIG. 7, defined as portions where the permanent magnets 58, 58 are disposed so that a direction of a magnetic flux by the permanent magnets 58, 58 is orthogonal to a movement direction of the movable contact 230 with respect to the fixed contact 220 (i.e., the up-down direction in FIG. 7).

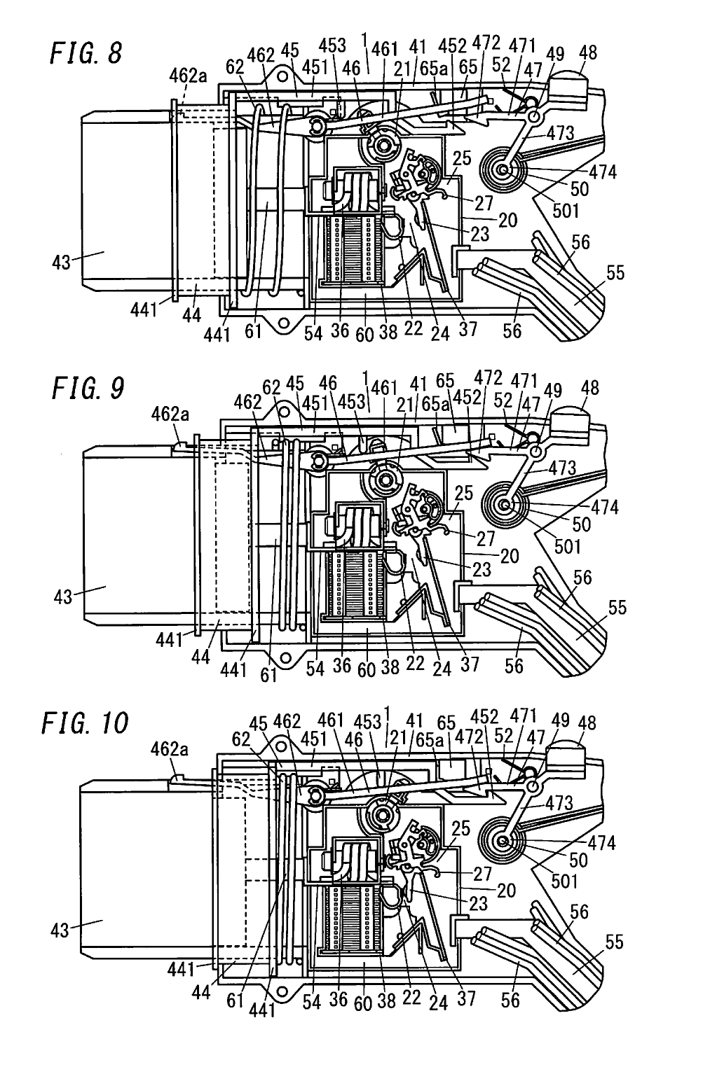

Next, operation of the connector 1 for electrical connection will be described with reference to FIGS. 8 to 10.

FIG. 8 shows the connector 1 for electrical connection in a state before being connected to the vehicle side inlet 300 (see FIG. 15) of the electrically driven vehicle 2. In this state, because the handle 21 of the contact mechanism portion 60 is at the open position where the contact mechanism is opened, the movable contacts 230 are respectively in states of being separated from the fixed contacts 220. At this time, because the lever 65a of the microswitch 65 receives no pressing for from the slide lever 45, its contact (not shown) is OFF, and the pin 501 of the solenoid device 50 is in a retreated state. Note that, because operation of the contact mechanism portion 60 is already described above, explanation thereof is omitted here.

When an operator inserts the contact portion 43 into the vehicle side inlet 300 of the electrically driven vehicle 2, the tubular body 44, as shown in FIG. 9, is pressed backward against the spring force of the return spring 62, and the slide lever 45 is moved backward. At this time, the engagement projection 462a of the second member 462 is pressed upward by receiving the elastic force of the torsion spring. At this time, although the handle 21 is pressed backward by the flange 453 of the slide lever 45, the handle 21 is not still moved to the close position where the contact mechanism is closed. That is, the movable contacts 230 are respectively still in the states of being separated from the fixed contacts 220.

When the operator inserts the contact portion 43 to a prescribed position in the vehicle side inlet 300, the front side flange portion 441 of the tubular body 44 as shown in FIG. 10 abuts on the front surface of the main body 41, and the engagement projection 452 of the slide lever 45 is engaged with the engagement projection 472 of the release lever 47. At this time, the handle 21 of the contact mechanism portion 60 is moved to the close position where the contact mechanism is closed, by receiving the pressing force of the flange 453, and accordingly, the movable contacts 230 come into contact with the fixed contacts 220.

Further at this time, the engagement projection 462a of the second member 462 of the lock lever 46 is engaged with an engagement groove (not shown) provided in the vehicle side inlet 300, and accordingly, the connector 1 for electrical connection is locked to the vehicle side inlet 300. Further at this time, the lever 65a of the microswitch 65 is pressed backward by the slide lever 45, and the contact of the microswitch 65 is turned on. According to turning on of the contact of the microswitch 65, the pin 501 of the solenoid device 50 is advanced, and inserted into the tubular portion 474 of the release lever 47. Therefore, the release lever 47 falls in a state of not accepting operation.

When charging to the electrically driven vehicle 2 is completed, a charging completion signal is output from the side of the electrically driven vehicle 2. The solenoid device 50 is driven in response to this charging completion signal, and the pin 501 falls in the retreated state. Then, the engagement state between the engagement projection 452 of the slide lever 45 and the engagement projection 472 of the release lever 47 is released by the operator pressing the release button 48 downward. At this time, the second member 462 of the lock lever 46 is pressed downward, and thereby, the engagement state between the engagement projection 462a and the engagement groove is also released.

Then, the operator can remove the connector 1 for electrical connection by pulling it toward oneself. At this time, the tubular body 44 and the slide lever 45 are moved forward by the spring force of the return spring 62, and the handle 21 is moved to the open position where the contact mechanism is opened by receiving force applied from the slide lever 45. Therefore, the movable contacts 230 are separated from the fixed contacts 220. Here in the embodiment, the handle 21, the slide lever 45 and the release lever 47 constitute a switching mechanism.

When an abnormality is detected by the electromagnetic releasing portion 36 or the thermal releasing portion 37 during charging to the electrically driven vehicle 2, the movable contact 230 is separated from the fixed contact 220. At this time, because the slide lever 45 forcibly holds the handle 21 at the close position by applying external force to the handle 21, the upper leg portion 280 of the first link member 28 is not moved and only the lower leg portion 281 of the first link member 28 is removed from the engagement portion 200 and moved.

There is a margin in a space where the lower leg portion 291 of the second link member 29 is engaged, and accordingly also regarding the second link member 29, the upper leg portion 290 is not moved and only the lower leg portion 291 is moved in the space. In other words, because the upper leg portion 280 of the first link member 28 and the upper leg portion 290 of the second link member 29, connected with the handle 21, are not moved, the handle 21 is maintained at the close position.

Further at this time, the slide lever 45 is not moved forward, and the contact of the microswitch 65 is still in the ON-state, and accordingly, the release lever 47 is in the state of not accepting operation. That is, in this state, the operator cannot remove the connector 1 for electrical connection from the electrically driven vehicle 2. After that, an abnormal detection signal is output from the side of the electrically driven vehicle 2 that has detected an abnormality. The solenoid device 50 is driven in response to this abnormal detection signal, and the pin 501 falls in the retreated state.

Then, the engagement state between the engagement projection 452 of the slide lever 45 and the engagement projection 472 of the release lever 47 is released by the operator pushing the release button 48 downward. Then, the operator can remove the connector 1 for electrical connection by pulling it toward oneself. At this time, the handle 21 is moved to the prescribed open position by receiving force applied from the slide lever 45, and accordingly, the trip state caused by the abnormality is released.

Here in the embodiment, in order to suppress electric arc generation at the contact portion 43, the following measures are taken. First, when the connector 1 for electrical connection is connected with the vehicle side inlet 300, after contact of contact pins 61 of the contact portion 43 with contact pins 301 (see FIG. 15) of the vehicle side inlet 300 is completed, the movable contacts 230 are brought into contact with the fixed contacts 220.

Further, when the connector 1 for electrical connection is removed from the vehicle side inlet 300, after separation of the movable contacts 230 from the fixed contacts 220 is completed, the contact pins 61 of the contact portion 43 are separated from the contact pins 301 of the vehicle side inlet 300. Therefore, it is possible to suppress an electric arc from generating between the contact pins 61 of the contact portion 43 and the contact pins 301 of the vehicle side inlet 300.

Thus, according to the embodiment, the main body 41 (including the contact portion 43, the power cutoff portion 10, the abnormality transmitter 11, the abnormality detector 12 and the handle 21) is provided at an end portion of the electric cable CB1, and nothing is interposed in the electric cable CB1. For this reason, the operator can easily return the electric cable CB1 to its original place. Therefore, it is possible to provide the connector 1 for electrical connection improving usability.

In addition, according to the embodiment, it is possible to provide the connector 1 having a protective function with respect to electric power from the side of the electrically driven vehicle 2. Therefore, even when a short-circuit abnormality or an electrical leakage abnormality occurs in a wiring region between a control box and a connector of the electrically driven vehicle 2, it is possible to protect circuits. Furthermore, the power cutoff portion 10 and the abnormality detector 12 are provided separately. For this reason, when changing a detection level for a short-circuit current or an overload current, it can be achieved by exchanging only the abnormality detector 12 with another abnormality detector 12. Therefore, the connector 1 further has an advantage that it is possible to easily change the detection level.

FIG. 2 is a schematic block diagram illustrating another example of the connector 1 for electrical connection according to the embodiment. Regarding the example shown in FIG. 1, the abnormality detector 12 (first abnormality detector) is configured to detect a short-circuit current or an overload current flowing in the feed line. On the other hand, the present example in FIG. 2 further includes a ground circuit 15 including resistors R1 to R3, which is configured to detect a ground fault current or a leakage current.

Further in the present example, a connection failure of the contact portion 43 is detected using a microswitch or the like, and a temperature abnormality of the contact portion 43 is detected using a thermal sensor. Therefore, it is possible to provide the connector 1 for electrical connection, having higher safety than that in FIG. 1.

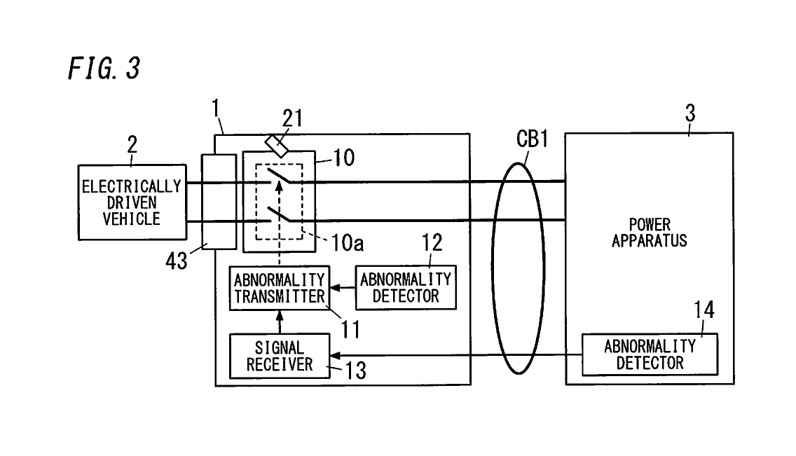

FIG. 3 is a schematic block diagram illustrating yet another example of the connector 1 for electrical connection according to the embodiment. In the present example, the power apparatus 3 is provided with an abnormality detector 14, and the connector 1 for electrical connection further includes a signal receiver 13 that is configured to receive an abnormal signal to be output from this abnormality detector 14. When the signal receiver 13 receives the abnormal signal output from the abnormality detector 14, the abnormality transmitter 11 opens the electric conductor 10a of the power cutoff portion 10 according to the abnormal signal, and thereby the feed line is opened.

Specifically, the abnormality detector 14 is configured to detect an abnormality occurring in the power apparatus 3 or an abnormality occurring in an electric circuit between the power apparatus 3 and a prescribed power source (not shown) supplying electric power to the power apparatus 3, and output the abnormal signal to the signal receiver 13. When the signal receiver 13 receives the abnormal signal, the trip state is spuriously realized by intentionally making an excessive current flow to the coil 360 or the bimetal plate 370, and thereby the movable contact 230 is separated from the fixed contact 220, and the feed line is opened.

In this way, the feed line is cut off according to the abnormal signal from the power apparatus 3 provided separately from the connector 1 for electrical connection. Accordingly, it is possible to detect abnormalities over a wider area, and cut off the feed line. Here in the embodiment, the abnormality detector 14 corresponds to a second abnormality detector, and may be configured to detect, as an abnormality, a ground fault current or a leakage current, in addition to a short-circuit current or an overload current similarly to the abnormality detector 12. Further, the abnormality detector 14 may be configured to detect, as an abnormality, a connection failure or a temperature abnormality of the contact portion 43.

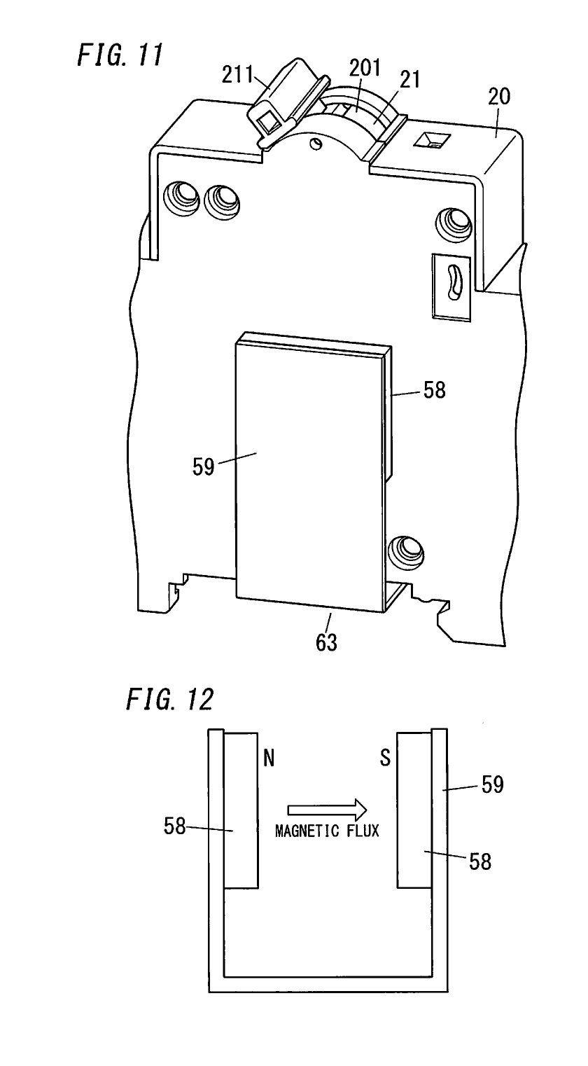

FIGS. 11 and 12 show another example of the DC extinguishing device 63 according to the embodiment, and the housing 20 is utilized, instead of the casing 57 (first casing) in FIG. 7. In this case, as shown in FIG. 11, the housing 20 is held between two portions, extending in parallel, of the U-shaped yoke 59, and further, the permanent magnets 58, 58 are disposed at portions corresponding to the fixed contact plates 22 and the movable bars 23 housed in the housing 20. In this case, the casing 57 is not required, and the cost can be reduced.

Here in the present example, the housing 20 corresponds to a second casing, and portions corresponding to the fixed contact plate 22 and the movable bar 23 are defined as portions where a direction of a magnetic flux by the permanent magnets 58, 58 is orthogonal to a movement direction of the movable contact 230 with respect to the fixed contact 220.

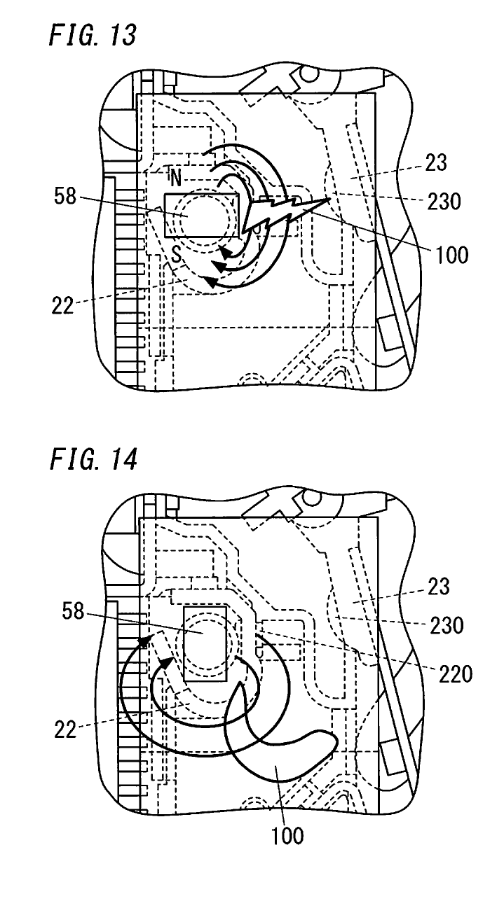

As shown in FIGS. 13 and 14, the permanent magnets 58, 58 may be disposed to be turned to change the direction of the magnetic field according to the turning operation of the handle 21. Accordingly, even when arc drive by a self-magnetic field is not achieved due to a relatively-low current, an electric arc 100 can be extended and cut off by an external magnetic field.

FIG. 15 is a schematic diagram illustrating another example of the power cutoff portion 10 in the connector 1 for electrical connection according to the embodiment. In the example already described above, the power cutoff portion 10 includes the pair of electric conductors 10a, which are respectively connected in series with two wires of the electric cable CB1. On the other hand, in the present example, the power cutoff portion 10 includes two transistors Q1, Q2.

The transistor Q2 is an npn-type transistor. A base of the transistor Q2 is connected with an end of a microswitch 16 via a resistor R4 and a switch SW1. An emitter of the transistor Q2 is connected with a contact pin 61 and a wire of the electric cable CB1 on the negative side. The transistor Q1 is a pnp-type transistor. An emitter of the transistor Q1 is connected with a contact pin 61 on the positive side. A collector of the transistor Q1 is connected with a wire of the electric cable CB1 on the positive side.

A base of the transistor Q1 is connected with a collector of the transistor Q2 via a resistor R5. Another end of the microswitch 16 is connected with a positive power source. Accordingly, when the microswitch 16 is turned on, a current flows between the base and the emitter of the transistor Q2 via the resistor R4 and the switch SW1.

In the case of this connector 1 for electrical connection, when the contact portion 43 is inserted into the vehicle side inlet 300 of the electrically driven vehicle 2, the respective contact pins 61 of the contact portion 43 are brought into contact with the contact pins 301 of the vehicle side inlet 300. Further, when the contact portion 43 reaches the prescribed position in the vehicle side inlet 300, the microswitch 16 is turned on and accordingly the current flows between the base and the emitter of the transistor Q2, and thereby a current path between the collector and the emitter of the transistor Q2 is turned on.

According to turning on of the current path between the collector and the emitter of the transistor Q2, a current flows between the emitter and the base of the transistor Q1, and thereby a current path between the emitter and the collector of the transistor Q1 is turned on, and the contact pin 61 on the positive side is electrically connected with the wire of the electric cable CB1 on the positive side. Therefore, DC power is supplied from the power apparatus 3 to the electrically driven vehicle 2 via the connector 1 for electrical connection. Here in the embodiment, the transistor Q1 and the microswitch 16 correspond to a switch and an on/off-switching portion, respectively.

When the connector 1 for electrical connection is removed from the vehicle side inlet 300, the microswitch 16 is turned off before disconnection of the contact pins 61 with the contact pins 301 is completed. Accordingly, the transistors Q1, Q2 are turned off beforehand, and then the contact pins 61 are disconnected with the contact pins 301. Therefore, also in the case of the present example, it is possible to suppress an electric arc from generating between the contact pins 61 of the contact portion 43 and the contact pins 301 of the vehicle side inlet 300.

In addition, when the abnormality detector 12 detects a short-circuit current or an overload current during charging from the power apparatus 3 to the electrically driven vehicle 2, the switch SW1 is turned off by the abnormality transmitter 11, and the transistors Q1, Q2 are turned off. Accordingly, the feed line of electric power to be fed from the power apparatus 3 to the electrically driven vehicle 2 is cut off, and supplying to the electrically driven vehicle 2 is stopped.

Examples of the abnormality to be detected by the abnormality detector 12 include a ground fault current, a leakage current, a connection failure of the contact portion 43, and a temperature abnormality that occurs at the contact portion 43. Here in the embodiment, the abnormality transmitter 11 and the switch SW1 correspond to a switch-off portion.

In the embodiment, a case where the power apparatus 3 is a DC/AC power converter is described above, as an example. However, the power apparatus 3 is not limited to the embodiment, and may be configured to supply AC power to the electrically driven vehicle 2. In this case, a function of converting AC power into DC power needs to be provided on the side of the electrically driven vehicle 2. In the embodiment, a case of supplying of electric power from the power apparatus 3 to the electrically driven vehicle 2 is described above, as an example. However, the connector 1 for electrical connection may be used for supplying of electric power from the electrically driven vehicle 2 to the power apparatus 3, or for bidirectionally supplying of electric power.

In the embodiment, the connector 1 for electrical connection to be connected with the vehicle side inlet 300 of the electrically driven vehicle 2 is described above. However, the connection destination of the connector 1 for electrical connection is not limited to the embodiment, and the connector 1 for electrical connection may be used for a portion to be connected with the power apparatus 3. In the embodiment, the power cutoff portion 10 is constituted by the electric conductors 10a and the like, or by the transistors Q1, Q2 and the like. However, constituent elements of the power cutoff portion 10 are not limited to those, and the power cutoff portion 10 may be constituted by fuse and the like.

The connector 1 for electrical connection may be configured to detect a quake due to an earthquake with the abnormality detector 12 or/and the abnormality detector 14 and stop charging to the electrically driven vehicle 2 when the magnitude of the quake is determined to be a prescribed value or more. In the embodiment, a case is described above, where the abnormality detector 12 is configured to directly detect an abnormality that occurs in the feed line. However, for example, the abnormality detector 12 may be configured to externally receive an abnormal signal, and the abnormality transmitter 11 may be configured to open the electric conductors 10a according to the abnormal signal received by the abnormality detector 12. In this case, the signal receiver 13 is not required, and the cost can be reduced.

As shown in FIG. 16, the main body 41 of the connector 1 for electrical connection may have an approximately quadrangular cylindrical profile. In this case, because a component (the contact mechanism portion 60) corresponding to a breaker in the main body originally has a quadrangle, it is possible to design appearance to match the shape of the component. Therefore, it is possible to save time and effort for designing the component corresponding to the inner breaker, and effectively utilize an internal space of the main body 41, and eliminate a useless space in the internal space of the main body 41, and contribute to the miniaturization of the connector 1 for electrical connection.

The connector 1 for electrical connection for an electrically driven vehicle, according to the embodiment, is configured to electrically connect the electrically driven vehicle 2, which includes a power storage portion, with the power apparatus 3. The power apparatus 3 is configured to control at least one of supplying of electric power to the electrically driven vehicle 2 or supplying of electric power from the electrically driven vehicle 2. The connector 1 includes the contact portion 43 and the main body 41. The contact portion 43 is configured to electrically connect the electric cable CB1, electrically connected with one of the electrically driven vehicle 2 or the power apparatus 3, with the other of the electrically driven vehicle 2 or the power apparatus 3. The main body 41 houses therein the contact portion 43, the power cutoff portion 10, and the abnormality detector 12 (first abnormality detector). The power cutoff portion 10 is configured to switch opening/closing of the feed line between the electrically driven vehicle 2 and the power apparatus 3. The abnormality detector 12 (first abnormality detector) is configured to detect the abnormality that occurs in the feed line, or externally receive the abnormal signal. The power cutoff portion 10 is configured to open the feed line, when the abnormality detector 12 detects the abnormality or receives the abnormal signal. The abnormality detector 12 is configured to detect, as the abnormality, at least one of the short-circuit current in the feed line or the overload current in the feed line.

Preferably, as the connector 1 for electrical connection according to the embodiment, the power cutoff portion 10 includes the electric conductor 10a connected in series with the electric cable CB1, and is configured to switch opening/closing of the feed line by bringing the first end of the electric conductor 10a into contact with the second end of the electric conductor 10a or releasing the electric conductor 10a from the contact state. In this case, the main body 41 further houses therein the abnormality transmitter 11 and the handle 21 (switching mechanism). The abnormality transmitter 11 is configured to mechanically release the electric conductor 10a from the contact state, when the abnormality detector 12 detects the abnormality or receives the abnormal signal. The handle 21 is configured to mechanically bring the first end of the electric conductor 10a into contact with the second end of the electric conductor 10a or release the electric conductor 10a from the contact state, in the state where the abnormality detector 12 detects no abnormality and receives no abnormal signal.

Preferably, as the connector 1 for electrical connection according to the embodiment, when the contact portion 43 is connected with the electrically driven vehicle 2 or the power apparatus 3, the handle 21 is configured to bring the first end of the electric conductor 10a into contact with the second end of the electric conductor 10a after connection of the contact portion 43 is completed. In this case, when the contact portion 43 is disconnected with the electrically driven vehicle 2 or the power apparatus 3, the handle 21 is configured to release the electric conductor 10a from the contact state before disconnection of the contact portion 43 is completed.

Preferably, as the connector 1 for electrical connection according to the embodiment, the abnormality detector 12 is configured to further detect, as the abnormality, at least one of the ground fault current in the feed line, the leakage current in the feed line, the connection failure of the contact portion 43, or the temperature abnormality that occurs at the contact portion 43.

Preferably, the connector 1 for electrical connection according to the embodiment further includes the signal receiver 13 configured to receive the abnormal signal that is output from the abnormality detector 14 (second abnormality detector) provided outside the main body 41. In this case, the abnormality transmitter 11 is configured to release the electric conductor 10a from the contact state when the signal receiver 13 receives the abnormal signal.

Preferably, as the connector 1 for electrical connection according to the embodiment, the electric conductor 10a includes the fixed contact 220 (fixed contactor), and the movable contact 230 (movable contactor) to be separably brought into contact with the fixed contact 220. In this case, the electric conductor 10a is housed in the casing 57 (first casing) formed of insulating material. The power cutoff portion 10 further includes the pair of permanent magnets 58, and the yoke 59. The permanent magnets 58 are disposed while the N-pole of one of the permanent magnets 58 faces the S-pole of the other of the permanent magnets 58 so as to hold, between the permanent magnets 58, the electric arc that is generated by the movable contact 230 being separated from the fixed contact 220. The yoke 59 is magnetically connected with the permanent magnets 58 so as to form the magnetic path together with the permanent magnets 58. The yoke 59 is disposed outside the casing 57, and the permanent magnets 58 are disposed at portions outside the casing 57, corresponding to the fixed contact 220 and the movable contact 230.

Preferably, as the connector 1 for electrical connection according to the embodiment, the casing 57 is configured as the housing 20 (second casing) housing therein at least the power cutoff portion 10, the abnormality detector 12, the abnormality transmitter 11 and the handle 21.

Preferably, as the connector 1 for electrical connection according to the embodiment, the permanent magnets 58 are disposed near the fixed contact 220 so as to turn according to operation of the handle 21 to change the direction of the magnetic field.

Preferably, as the connector 1 for electrical connection according to the embodiment, the power cutoff portion 10 further includes the extinguishing device 38 (extinguishing portion). In this case, the extinguishing device 38 includes the arc running plate 380 and the extinguishing grid 381. The arc running plate 380 is configured to transfer the electric arc generated by the movable contact 230 being separated from the fixed contact 220. The extinguishing grid 381 is configured to extinguish the electric arc transferred by the arc running plate 380.

Preferably, as the connector 1 for electrical connection according to the embodiment, the power cutoff portion 10 includes: the transistor Q1 (switch) connected in series with the electric cable CB1; and the microswitch 16 (on/off-switching portion) configured to switch on/off of the transistor Q1 to switch opening/closing of the feed line. In this case, the main body 41 houses therein the switch-off portion (the abnormality transmitter 11 and the switch SW1) that is configured to turn off the transistor Q1, when the abnormality detector 12 detects the abnormality or receives the abnormal signal.

Preferably, as the connector 1 for electrical connection according to the embodiment, when the contact portion 43 is connected with the electrically driven vehicle 2 or the power apparatus 3, the microswitch 16 is configured to turn on the transistor Q1 after connection of the contact portion 43 is completed. In this case, when the contact portion 43 is disconnected with the electrically driven vehicle 2 or the power apparatus 3, the microswitch 16 is configured to turn off the transistor Q1 before disconnection of the contact portion 43 is completed.

Preferably, as the connector 1 for electrical connection according to the embodiment, the abnormality detector 12 is configured to further detect, as the abnormality, at least one of the ground fault current in the feed line, the leakage current in the feed line, the connection failure of the contact portion 43, or the temperature abnormality that occurs at the contact portion 43.

Note that, a connector for electrical connection, for an electrically driven vehicle, is disposed at an end of an electric cable for connecting the electrically driven vehicle, which includes a power storage portion, with a power apparatus. The power apparatus is configured to control at least one of supplying of a charging current to the power storage portion or receiving of a discharging current from the power storage portion. The connector is configured to be detachably connected with at least one of a socket provided at the electrically driven vehicle or a socket provided at the power apparatus. The connector includes: a main body that is provided at an end thereof with a contact portion to be inserted into the socket; and a contact mechanism portion that is housed in the main body. The contact portion includes second terminals to respectively be electrically connected with first terminals of the socket when inserted into the socket. The contact mechanism portion includes: a contact part to be inserted between at least one second terminal of the second terminals and a wire of the electric cable connected with the one second terminal; a switching mechanism configured to switch opening/closing of the contact part; an abnormality detector configured to detect an abnormality in a current that flows through the electric cable; and an abnormality transmitter configured to allow opening of the contact part when the abnormality detector detects the abnormality. The connector includes: a connection mechanism configured to allow moving of the contact portion between a removing position where the contact portion is removed from the socket and an attachment position where the contact portion is attached to the socket and the respective second terminals are electrically connected with the first terminals; a lock means configured to lock the connection state between the contact portion and the socket; and a release means configured to release the lock state by the lock means so that the contact portion can be removed from the socket. The switching mechanism is configured to close the contact part after the contact portion is moved from the removing position to the attachment position by linking with the connection mechanism, and open the contact part when the lock state by the lock means is released by linking with the release means.

1. A connector for electrical connection for an electrically driven vehicle, the connector being configured to electrically connect the electrically driven vehicle, which includes a power storage portion, with a power apparatus,
the power apparatus being configured to control at least one of supplying of electric power to the electrically driven vehicle or supplying of electric power from the electrically driven vehicle,
the connector comprising:
a contact portion configured to electrically connect an electric cable, electrically connected with one of the electrically driven vehicle or the power apparatus, with an other of the electrically driven vehicle or the power apparatus; and
a main body housing therein the contact portion, a power cutoff portion and a first abnormality detector, the power cutoff portion being configured to switch opening/closing of a feed line between the electrically driven vehicle and the power apparatus, the first abnormality detector being configured to detect an abnormality that occurs in the feed line, or externally receive an abnormal signal,
the power cutoff portion being configured to open the feed line, when the first abnormality detector detects the abnormality or receives the abnormal signal,
the first abnormality detector being configured to detect, as the abnormality, at least one of a short-circuit current in the feed line or an overload current in the feed line.

2. The connector for electrical connection according to claim 1,
wherein the power cutoff portion comprises an electric conductor connected in series with the electric cable, the power cutoff portion being configured to switch opening/closing of the feed line by bringing a first end of the electric conductor into contact with a second end of the electric conductor or releasing the electric conductor from a contact state, and
wherein the main body further houses therein an abnormality transmitter and a switching mechanism,
the abnormality transmitter being configured to mechanically release the electric conductor from the contact state, when the first abnormality detector detects the abnormality or receives the abnormal signal,
the switching mechanism being configured to mechanically bring the first end of the electric conductor into contact with the second end of the electric conductor or release the electric conductor from the contact state, in a state where the first abnormality detector detects no abnormality and receives no abnormal signal.

3. The connector for electrical connection according to claim 2,
wherein when the contact portion is connected with the electrically driven vehicle or the power apparatus, the switching mechanism is configured to bring the first end of the electric conductor into contact with the second end of the electric conductor after connection of the contact portion is completed, and
wherein when the contact portion is disconnected with the electrically driven vehicle or the power apparatus, the switching mechanism is configured to release the electric conductor from the contact state before disconnection of the contact portion is completed.

4. The connector for electrical connection according to claim 1,
wherein the first abnormality detector is configured to further detect, as the abnormality, at least one of a ground fault current in the feed line, a leakage current in the feed line, a connection failure of the contact portion, or a temperature abnormality that occurs at the contact portion.

5. The connector for electrical connection according to claim 2, further comprising a signal receiver configured to receive the abnormal signal that is output from a second abnormality detector provided outside the main body,
wherein the abnormality transmitter is configured to release the electric conductor from the contact state when the signal receiver receives the abnormal signal.

6. The connector for electrical connection according to claim 2,
wherein the electric conductor comprises a fixed contactor, and a movable contactor to be separably brought into contact with the fixed contactor,
the electric conductor being housed in a first casing formed of insulating material,
wherein the power cutoff portion further comprises:
a pair of permanent magnets disposed while an N-pole of one of the permanent magnets faces an S-pole of an other of the permanent magnets so as to hold, between the permanent magnets, an electric arc that is generated by the movable contactor being separated from the fixed contactor; and
a yoke magnetically connected with the permanent magnets so as to form a magnetic path together with the permanent magnets, and
wherein the yoke is disposed outside the first casing, and the permanent magnets are disposed at portions outside the first casing, corresponding to the fixed contactor and the movable contactor.

7. The connector for electrical connection according to claim 6,
wherein the first casing is configured as a second casing housing therein at least the power cutoff portion, the first abnormality detector, the abnormality transmitter and the switching mechanism.

8. The connector for electrical connection according to claim 6,
wherein the permanent magnets are disposed near the fixed contactor so as to turn according to operation of the switching mechanism to change a direction of a magnetic field.

9. The connector for electrical connection according to claim 6,
wherein the power cutoff portion further comprises an extinguishing portion,
the extinguishing portion comprising:
an arc running plate configured to transfer the electric arc generated by the movable contactor being separated from the fixed contactor; and
an extinguishing grid plate configured to extinguish the electric arc transferred by the arc running plate.

10. The connector for electrical connection according to claim 1,
wherein the power cutoff portion comprises:
a switch connected in series with the electric cable; and
an on/off-switching portion configured to switch on/off of the switch to switch opening/closing of the feed line, and
wherein the main body houses therein a switch-off portion that is configured to turn off the switch, when the first abnormality detector detects the abnormality or receives the abnormal signal.

11. The connector for electrical connection according to claim 10,
wherein when the contact portion is connected with the electrically driven vehicle or the power apparatus, the on/off-switching portion is configured to turn on the switch after connection of the contact portion is completed, and
wherein when the contact portion is disconnected with the electrically driven vehicle or the power apparatus, the on/off-switching portion is configured to turn off the switch before disconnection of the contact portion is completed.

12. The connector for electrical connection according to claim 10,
wherein the first abnormality detector is configured to further detect, as the abnormality, at least one of a ground fault current in the feed line, a leakage current in the feed line, a connection failure of the contact portion, or a temperature abnormality that occurs at the contact portion.

13. The connector for electrical connection according to claim 2,
wherein the first abnormality detector is configured to further detect, as the abnormality, at least one of a ground fault current in the feed line, a leakage current in the feed line, a connection failure of the contact portion, or a temperature abnormality that occurs at the contact portion.

14. The connector for electrical connection according to claim 3,
wherein the first abnormality detector is configured to further detect, as the abnormality, at least one of a ground fault current in the feed line, a leakage current in the feed line, a connection failure of the contact portion, or a temperature abnormality that occurs at the contact portion.

15. The connector for electrical connection according to claim 3, further comprising a signal receiver configured to receive the abnormal signal that is output from a second abnormality detector provided outside the main body,
wherein the abnormality transmitter is configured to release the electric conductor from the contact state when the signal receiver receives the abnormal signal.

16. The connector for electrical connection according to claim 4, further comprising a signal receiver configured to receive the abnormal signal that is output from a second abnormality detector provided outside the main body,
wherein the abnormality transmitter is configured to release the electric conductor from the contact state when the signal receiver receives the abnormal signal.

17. The connector for electrical connection according to claim 13, further comprising a signal receiver configured to receive the abnormal signal that is output from a second abnormality detector provided outside the main body,
wherein the abnormality transmitter is configured to release the electric conductor from the contact state when the signal receiver receives the abnormal signal.

18. The connector for electrical connection according to claim 14, further comprising a signal receiver configured to receive the abnormal signal that is output from a second abnormality detector provided outside the main body,
wherein the abnormality transmitter is configured to release the electric conductor from the contact state when the signal receiver receives the abnormal signal.
